(19) United States
(12) Patent Application Publication
(10) Pub. No.: US 2012/0094650 A1
(43) Pub. Date: Apr. 19, 2012

(54) METHOD OF COMMUNICATION

(76) Inventors: Zhongding Lei, Singapore (SG); Po Shin Francois Chin, Singapore (SG); Quee Seng Quek, Singapore (SG); Kwok Shum Au, Singapore (SG)

(21) Appl. No.: 13/255,093

(22) PCT Filed: Mar. 2, 2010
(86) PCT No.: PCT/SG2010/000073

§ 371 Date: Sep. 6, 2011

(30) Foreign Application Priority Data
Mar. 3, 2009 (SG) 2009015413

(51) Int. Cl. H04W 8/00

(52) U.S. Cl. 455/422.1

(57) ABSTRACT

A method of communication comprising: determining whether a mobile station (MS) is within a collaborative zone with respect to a first base station (BS₁), if the MS is within the collaborative zone (704): the BS₁ transmitting one or more collaboration parameters to a network coordinator (706), the network coordinator determining one or more collaborative base stations depending on the collaboration parameters, the network coordinator transmitting control parameters to the BS₁ and the one or more collaborative base stations (BS₂) (708), and the BS₁ transmits via wired backhaul the data to be transmitted to the MS and channel information between the MS and the BS₁ in accordance with the control parameters to the BS₂ (710), the BS₁ and the BS₂ collaboratively transmitting data to the MS in accordance with the control parameters (712). Also an integrated circuit, a mobile station, a base station and a network coordinator.

### FIELD AND BACKGROUND OF THE INVENTION

The present invention relates to a method of communication, particularly though not exclusively, to cell collaborative zones for cellular systems.

The next generation (4G) wireless technology is the new era of wireless technology based on the integration of new technologies that enable high data rates, offer seamless mobility, and interoperability. 4G is the next step towards transferring high volumes of data while being better connected. It will offer very high data rates that would be well suited to handle multimedia applications.

There is almost unanimous agreement in the industry that 4G systems would employ the Multiple Input Multiple Output (MIMO) technology. This is because MIMO is very proficient in increasing system throughput and performance. The capacity of a point-to-point link scales linearly with the number of antennas deployed even without increasing the transmission power or bandwidth. The capacity gain provisioned by MIMO, however, could be marginal when the link qualities are poor. This may be especially true unfortunately for the 4G cellular system which is expected to be an inter-cell interference (ICI) limited system due to efficient frequency reuse cells to be deployed, such as one-cell frequency reuse.

Network MIMO is a new technology developing towards lifting the interference limits on wireless network. It minimises the ICI through coordinating the simultaneous transmissions among multiple cells. It has been shown that a significant improvement can be achieved which could be as large as an order of magnitude in system throughput. In view of the significant advantages of the Network MIMO, the 3^{rd} Generation Partnership Project (3GPP) has recently included Network MIMO in its developing specification for 4G in the name of the Long Term Evolution Advanced (LTE-Advanced) to improve the coverage of high data rates, the cell-edge throughput and/or increase system throughput. IEEE 802.16m working group for next generation Broadband Wireless Access is also considering Network MIMO as its advanced interference management technology to meet the cellular layer requirements of International Mobile Telecommunications Advanced (IMT-Advanced) for next generation mobile networks.

However, the coordination amongst different cells/base stations (BSs) in Network MIMO requires a high-speed backbone enabling information exchange, including data, control signals, and channel state information between the BSs.

### SUMMARY OF THE INVENTION

In general terms, the invention proposes a strategy for defining a collaborative zone between cells for Network MIMO.

In order to make Network MIMO more feasible, the amount of information required to be exchanged amongst different cells/BSs may be reduced. A collaborative zone for each cell is defined, and only those users within the collaborative zone may be served by multiple coordinated cells/BSs. Other users outside the collaborative zone may be served by a single cell/BS as in a conventional non-collaborative scheme. Since the amount of control signals and channel information may be proportional to the square of the number of users served by the collaborative BSs and the amount of data may be proportional to the number of users served by the collaborative BSs, reducing the number of users to be served by the collaborative BSs may give rise to significant reduction of information needs to be exchanged.

The proposed collaborative zone may be defined according to the distance to the centre of the cell/BS. It may also be defined according to other parameters such as the contour of the average signal-to-interference-and-noise ratio (SINR) in a cell/BS. Users which are outside the properly determined collaborative zone and served by a single BS may only suffer marginal capacity loss as opposed to the case where they would be served by collaborative BSs with intensive information exchanged. The determination of whether a mobile is within the well-defined collaborative zone of its serving BS may be determined solely by the BS separately in a distributed way. Further, only the information of the mobile concerned may be required for such decision and it may not need to know other mobile's instantaneous channel information.

According to a first specific expression of the invention, there is provided a method of communication comprising:
determining whether a mobile station (MS) is within a collaborative zone with respect to a first base station (BS₁),
if the MS is within the collaborative zone:
   the BS₁ transmitting one or more collaboration parameters to a network coordinator,
   the network coordinator determining one or more collaborative base stations (BS₂₋ₙ) depending on the collaboration parameters,
   the network coordinator transmitting control parameters to the BS₁ and the BS₂₋ₙ,
   the BS₁ exchanging information with the BS₂₋ₙ in accordance with the control parameters, and
   the BS₁ and the BS₂₋ₙ collaboratively transmitting data to the MS in is accordance with the control parameters.

The determining whether the MS is within the collaborative zone may comprise determining whether a distance between the MS and the BS₁ is over a predetermined threshold.

The determining whether the MS is within the collaborative zone may comprise determining whether a signal to noise ratio (SNR) is below a predetermined threshold.

The method may further comprise determining a collaborative zone threshold based on the minimal achievable rate of each MS.

The method may further comprise determining a collaborative zone threshold based on the sum rate of all MS within the collaborative zone of BS₁ and the BS₂₋ₙ.

The determining the collaborative zone threshold may also based on a correction factor for channel fading.

If the MS is not within the collaborative zone, the BS₁ may non collaboratively transmit data to the MS.

The one or more collaboration parameters may be selected from the group consisting of a BS₁ ID, a MS ID, a candidate resource, associable BS IDs and any combination thereof.

The control parameters may comprise transmission resources and/or collaborative BS IDs for each MS.

The determining of one or more collaborative base stations (BS₂₋ₙ) may comprise determining whether BS₁ is one of the associable BSs of another MS within a collaborative zone of one or more of the associable BSs of the MS in BS₁.

The BS₁ exchanging information with the BS₂₋ₙ may comprise the BS₁ transmitting via a wired backhaul data to be transmitted to the MS and the channel information between the MS and the BS₁ in accordance with the control parameters to the BS₂₋ₙ one or more other collaborative base stations.

The BS₁ exchanging information with the BS₂₋ₙ may further comprise the BS₁ receiving via the wired backhaul the data to be transmitted to a further mobile station (MS₂) within a collaborative zone of the BS₂₋ₙ and the channel information between the MS₂ and the respective BS₂₋ₙ in accordance with the control parameters.

The collaboratively transmitting data may comprise a linear zero-forcing collaboration scheme. This may eliminate ICI in the collaborative zone.

The collaboratively transmitting data may comprise a linear minimum-mean-squared-error collaboration scheme. This may minimize ICI taking into consideration noise enhancement issue in the collaborative zone.

The determining whether the MS is within the collaborative zone may be done independently by its associated BS. This may reduce complexity, processing time and amount of coordination required.

According to a second specific expression of the invention, there is provided a method for signal transmission from two or more base stations (BSs) collaboratively to one or more mobile stations (MSs) which have a 1st parameter with its associated BS exceeding/below a predetermined threshold, the method comprising:
each BS reporting to a network coordinator a BS ID, and the ID, candidate resources, and associable BS IDs for each of the associated MS,
the network coordinator determining the transmission resources and other collaborative BS IDs for each MS,
the network coordinator informing each BS, the transmission resources and said collaborative BS IDs for each MS,
each said BS exchanging information with said collaborative BSs for a MS that is associated to said each said BS, and
each said BS, together with said collaborative BSs transmit signals with the said transmission resources simultaneously to a group of MSs sharing the same BS set, said BS set comprising the associated BSs and collaborative BSs.

According to a third specific expression of the invention, there is provided an integrated circuit configured to communicate according to any of the above methods.

According to a forth specific expression of the invention, there is provided a mobile station configured to communicate according to any of the above methods.

According to a fifth specific expression of the invention, there is provided a base station configured to communicate according to any of the above methods.

According to a sixth specific expression of the invention, there is provided a network coordinator configured to communicate according to any of the methods.

### BRIEF DESCRIPTION OF THE DRAWINGS

In order that the invention may be fully understood and readily put into practical effect there shall now be described by way of non-limitative example only, an example embodiment described below with reference to the accompanying illustrative drawings in which:

FIG. 1 is a schematic drawing of a linear cellular array with two BSs, serving one MS each;

FIG. 2 is a graphed comparison of the achievable rates of the collaborative and non-collaborative BS transmission;

FIG. 3 is a graph of the achievable rate advantage of collaborative BS transmission vs. MS distance to serving BS;

FIG. 4 is a graph of the rate advantage of collaborative BS transmission vs. MS distance to serving BS;

FIG. 5 is a chart of an achievable rate of collaborative BS transmission in fading channels;

FIG. 6 is a chart of an achievable rate of collaborative BS transmission vs SNR in fading channels;

FIG. 7 is a flow diagram of a method of communication according to the example embodiment; and

FIG. 8 is a schematic drawing of the information exchanged with the network coordinator.

### DETAILED DESCRIPTION OF THE PREFERRED EMBODIMENT

### System Model

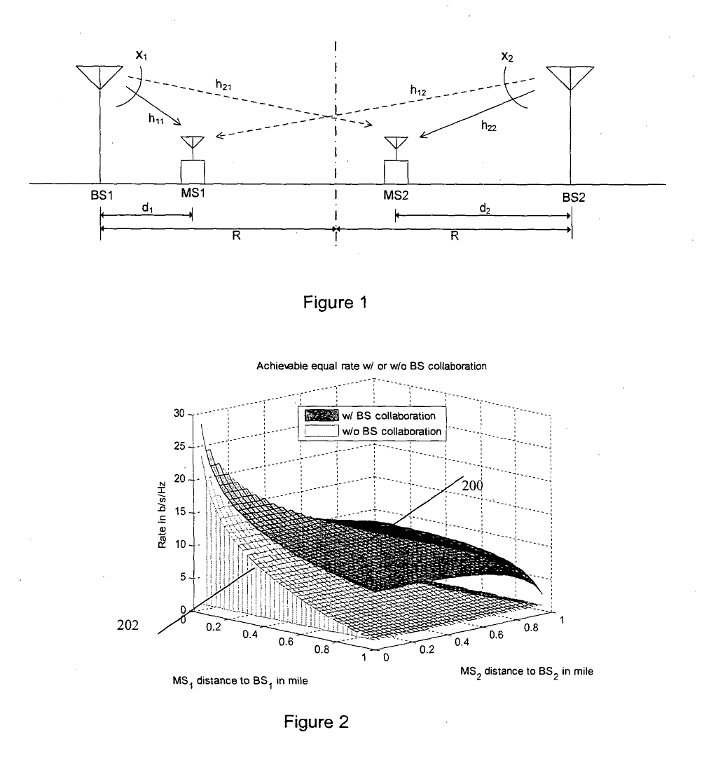

Consider a simple, idealized, synchronous, Wyner-type linear cellular, downlink communication model as shown in FIG. 1. Two BSs of neighbouring cells have been illustrated and each is serving one mobile station (MS). In a conventional OFDMA system, the MSs correspond to the two users in neighbouring cells allocated independently to the same bandwidth at a time, i.e. the same resource blocks for example in a 3GPP Long Term Evolution (LTE) system. This bandwidth allocation is popular in order to better utilize the system spectrum with one cell reuse factor. Of course, the two MSs will suffer interference from the non serving BS in a conventional non-collaborative BS setup, also known as ICI. A collaborative BS transmission scheme according to an example embodiment will be described and it will be shown that ICI may be minimised using the example embodiment.

The signal from the 2 single-antenna BSs received by the 2 single-antenna MSs can be represented mathematically as,

Y=H·x+n (1)

where the channel matrix

$$H = [ \begin{matrix}{h}_{11} & {h}_{12} \\ {h}_{21} & {h}_{22}\end{matrix} ]$$

with hᵢⱼ being the complex channel gain between MSᵢ and BSⱼ (i, j=1 or 2), x=[xₗ, x₂]^{T} denotes the BS outputs with x₁, x₂ being outputs from BS₁ and BS₂ respectively, and n=[n₁, n₂]^{T} denotes an additive white noise vector with covariance 61.

### Non-Collaborative BS Transmission

Without collaborative transmission, each BS transmits signals intended for the user within its cell coverage, and neighbouring BS transmissions in the same frequency band cause ICI. Given the system in FIG. 1, the antenna outputs at the BS₁ antenna and BS₂ antenna are the data symbols s₁ and s₂ for their associated mobile MS₁ and MS₂ respectively, i.e. x₁=s₁ and x₂=s₂ where s₁ and s₂ are assumed independent and identically distributed (i.i.d.) with zero mean and variances p₁ and p₂. We assume further that each BS is transmitting at full power, i.e., E[|x₁|²]=E[|x₂|²]=pₘₐₓ and hence the SINRs at MS₁ and MS₂ are given by

$$sin {r}_{1} = \frac{{p}_{ma x} \cdot {\vert {h}_{11} \vert}^{2}}{{p}_{ma x} \cdot {\vert {h}_{12} \vert}^{2} + {σ}^{2}} \\ sin {r}_{2} = \frac{{p}_{ma x} \cdot {\vert {h}_{22} \vert}^{2}}{{p}_{ma x} \cdot {\vert {h}_{21} \vert}^{2} + {σ}^{2}} \qquad ( 2 )$$

respectively. The corresponding instantaneous achievable rates are

$${r}_{1} = {log}_{2} ( 1 + \frac{{p}_{ma x} \cdot {\vert {h}_{11} \vert}^{2}}{{p}_{ma x} \cdot {\vert {h}_{12} \vert}^{2} + {σ}^{2}} ) ( b \text{/} symbol \text{/} Hz ) \\ {r}_{2} = {log}_{2} ( 1 + \frac{{p}_{ma x} \cdot {\vert {h}_{22} \vert}^{2}}{{p}_{ma x} \cdot {\vert {h}_{21} \vert}^{2} + {σ}^{2}} ) ( b \text{/} symbol \text{/} Hz ) \qquad ( 3 )$$

### Collaborative BS Transmission

When BS collaboration is employed, all collaborative BSs can act together and each mobile may receive useful signals from all BSs involved. The capacity achieving strategy on how to transmit to MSs collaboratively amongst BSs may require dirty paper coding (DPC) whose processing complexity may prohibit its implementation. In the example embodiment a linear zero-forcing collaboration to scheme is used. Other linear precoding schemes or combinations, such as the minimum-mean-squared error precoding scheme may also be used.

Denoting the data symbol vector for MSᵢ and MS₂ by s=[s₁, s₂]^{T}, a linear spatial pre-filter matrix

$$A = [ \begin{matrix}{a}_{11} & {a}_{12} \\ {a}_{21} & {a}_{22}\end{matrix} ] ∈ {C}^{2 \times 2}$$

is used to map the data symbols to the is antenna outputs, i.e.

x=A·s (4)

Thus, in the case of BS collaboration, the antenna outputs at BS₁ and BS₂ are a linear combination of two data symbols

x₁=a₁₁s₁+a₁₂S₂

x₂=a₂₁s₁+a₂₂s₂ (5)

The zero-forcing collaborative transmission is obtained by projecting the signals for other users away from the desired mobile's signal. Mathematically, a pseudo-inverse pre-filter matrix

A=H^{H}·(H·H^{H})⁻¹ (6)

is used to map the data symbols to the antenna outputs, x=H^{H}·(H·H^{H})⁻¹s. Notice that the received signal at MS₁ and MS₂ after such a pre-filtering, i.e. substituting (6) into (1), becomes

Y=H·H^{H}·(H·H^{H})⁻¹·s+n=s+n (7)

Thus the channel has been diagonalized and the received signal at each MS is interference-free. The corresponding Shannon rates can be written by

$${r}_{1}^{′} = {log}_{2} ( 1 + \frac{{p}_{1}}{{σ}^{2}} ) ( b \text{/} symbol \text{/} Hz ) \\ {r}_{2}^{′} = {log}_{2} ( 1 + \frac{{p}_{2}}{{σ}^{2}} ) ( b \text{/} symbol \text{/} Hz ) \qquad ( 8 )$$

where p₁=E[|s₁|²] and p₂=E[|s₂|²] are the symbol power.

### Achievable Rates

In this section, the achievable rates provisioned by different transmission schemes is compared, i.e. BS collaboration transmission and non-BS-collaboration transmission. This is to facilitate the investigation of the relationship of the capacity improvement due to BS collaboration and the distance of each MS to its serving BS in order to define a cell collaborative zone. As no coordination is considered for the conventional transmission, we have assumed each BS transmits at its full power. For the BS collaborative transmission, we can optimize the transmission power of each BS as well.

The metric for comparisons will be the max-min rate achievable subject to per BS power constraints. The max-min rate objective is motivated by the fairness concern, that is, the need to guarantee quality of service (QoS) for the users within the collaborative zone.

The achievable max-min rate for non-collaborative BS transmission is, with reference to (3) and full power transmission at each BS,

$${r}_{nc} = {log}_{2} [ 1 + {p}_{ma x} \cdot min ( \frac{{\vert {h}_{11} \vert}^{2}}{{p}_{ma x} \cdot {\vert {h}_{12} \vert}^{2} + {σ}^{2}} , \frac{{\vert {h}_{22} \vert}^{2}}{{p}_{ma x} \cdot {\vert {h}_{21} \vert}^{2} + {σ}^{2}} ) ] \qquad ( 9 )$$

To formulate the max-min rate optimization problem for BS collaborative transmission, we will specify per BS power constraints. Notice that BS₁ and BS₂ are subject to an average power constraint given by

E[|x₁|²]≦pₘₐₓ

E[|x₂|²]≦pₘₐₓ (10)

Substituting (10) with (5), the constraints can be transformed into a set of linear constraints in terms of the power of the data symbols p₁ and p₂ as

$$[ \begin{matrix}{\vert {a}_{11} \vert}^{2} & {\vert {a}_{12} \vert}^{2} \\ {\vert {a}_{21} \vert}^{2} & {\vert {a}_{22} \vert}^{2}\end{matrix} ] [ \begin{matrix}{p}_{1} \\ {p}_{2}\end{matrix} ] \leq [ \begin{matrix}{p}_{ma x} \\ {p}_{ma x}\end{matrix} ] \qquad ( 11 )$$

Therefore the problem of maximizing the minimum rate subject to per BS power constraints for collaborative BS transmission can be written as

$$max min \{ {r}_{1}^{′} , {r}_{2}^{′} \} \\ s . t . [ \begin{matrix}{\vert {a}_{11} \vert}^{2} & {\vert {a}_{12} \vert}^{2} \\ {\vert {a}_{21} \vert}^{2} & {\vert {a}_{22} \vert}^{2} \end{matrix} ] [ \begin{matrix}{p}_{1} \\ {p}_{2}\end{matrix} ] \leq [ \begin{matrix}{p}_{ma x} \\ {p}_{ma x}\end{matrix} ] \\ {p}_{1} \geq 0 , {p}_{2} \geq 0 , {r}_{1}^{′} \geq 0 , {r}_{2}^{′} \geq 0 \qquad ( 12 )$$

Since the rate functions are concave in the symbols' powers, and the power constraints are expressed as linear constraints, max-min rate optimization becomes a convex programming problem. In the example embodiment the closed-form solution may be obtained by solving the maximum common rate problem

$$max r \\ s . t . [ \begin{matrix}{\vert {a}_{11} \vert}^{2} & {\vert {a}_{12} \vert}^{2} \\ {\vert {a}_{21} \vert}^{2} & {\vert {a}_{22} \vert}^{2}\end{matrix} ] [ \begin{matrix}p \\ p\end{matrix} ] \leq [ \begin{matrix}{p}_{max} \\ {p}_{max}\end{matrix} ] \\ p = {p}_{1} = {p}_{2} \geq 0 , r = {r}_{1}^{′} = {r}_{2}^{′} \geq 0 \qquad ( 13 )$$

It is easy to verify that the optimal collaborative transmission power at each BS is

pₒₚₜ=pₘₐₓ/max{|a₁₁|²+|a₁₂|²,|a₂₁|²+|a₂₂|²} (14)

Therefore the max-min rate achievable for collaborative BS transmission is given by

$${r}_{co} = {log}_{2} [ 1 + \frac{{p}_{ma x}}{{σ}^{2} \cdot max ( {\vert {a}_{11} \vert}^{2} + {\vert {a}_{12} \vert}^{2} , {\vert {a}_{21} \vert}^{2} + {\vert {a}_{22} \vert}^{2} )} ] \qquad ( 15 )$$

### Cell Collaborative Zone

In this section, we will investigate the relationship of the capacity improvement due to BS collaboration and the distance of each MS to its serving BS in order to define a cell collaborative zone. The collaboration may increase the capacity within the collaborative zone, whereas only marginal capacity gain may be achieved outside the collaborative zone.

The MS location in a cell may impact the capacity improvement from BS collaborative transmission. It is beneficial to represent (15) and (9) in the function of the location, i.e. the distance of MS to its serving BS in our system setup. Toward this end, we first focus on average white Gaussian noise (AWGN) channel and introduce the path loss into the channel model. We will discuss the shadowing and fast fading effects thereafter.

### AWGN Channel

The distance dependent path loss has the form of K·d^{-γ}, where K is the path loss at a reference distance 1 mile, d is the distance between a MS and its serving BS, and γ is the path loss exponent. With reference to FIG. 1, the coefficients of the channel

$$H = [ \begin{matrix}{h}_{11} & {h}_{12} \\ {h}_{21} & {h}_{22}\end{matrix} ]$$

can be written as

h₁₁=K^{1/2}·d₁^{-γ/2}

h₁₂=K^{1/2}·(2R−d₁)^{-γ/2}

h₂₂=K^{1/2}·d₂^{-γ/2}

h₂₁=K^{1/2}·(2R−d₂)^{-γ/2} (16)

where R is the radius of the cell.

It is easy to verify that the channel matrix

$$H = [ \begin{matrix}{h}_{11} & {h}_{12} \\ {h}_{21} & {h}_{22}\end{matrix} ]$$

with coefficients shown in (16) is full rank when d₁<R and d₂<R. The pseudo-inverse-pre-filter matrix A in (6) can be simplified to the inverse matrix, i.e.

$$A = {H}^{- 1} = \frac{1}{det ( H )} [ \begin{matrix}{h}_{22} & - {h}_{12} \\ - {h}_{21} & {h}_{11}\end{matrix} ] \qquad ( 17 )$$

where det(H)=h₁₁h₂₂−h₁₂h₂₁. Substituting (16) into (17) gives us the coefficients of the zero forcing pre-filter matrix in the function of the MS distances to their serving cells explicitly as

a₁₁=K^{-1/2}·d₂^{-γ/2}/Δ(d₁,d₂)

a₂₂=K^{-γ/2}·d₁^{-γ/2}/Δ(d₁,d₂)

a₁₂=−K^{-1/2}·(2R−d₁)^{-γ/2}/Δ(d₁,d₂)

a₂₁=−K^{-1/2}·(2R−d₂)^{-γ/2}/γ(d₁,d₂) (18)

where

Δ(d₁,d₂)=(d₁d₂)^{-γ/2}−[(2R−d₁)(2R−d₂)]^{-γ/2} (19)

Substituting (18) and (16) into (15) and (9) respectively, we can obtain the following closed-form expressions of the achievable rates for collaborative BS and non-collaborative BS transmissions as

$$\begin{matrix}{r}_{co} = {log}_{2} [ 1 + \frac{{p}_{ma x} \cdot K \cdot {Δ}^{2} ( {d}_{1} , {d}_{2} )}{{σ}^{2} \cdot max ( {d}_{2}^{- γ} + {( 2 R - {d}_{1} )}^{γ} , {d}_{1}^{- γ} + {( 2 R - {d}_{2} )}^{- γ} )} ] & ( 20 ) \\ {r}_{nc} = {log}_{2} [ 1 + {p}_{ma x} \cdot K \cdot min ( \begin{matrix}\frac{{d}_{1}^{- γ}}{{p}_{ma x} \cdot K \cdot {( 2 R - {d}_{1} )}^{- γ} + {σ}^{2}} , \\ \frac{{d}_{2}^{- γ}}{{p}_{ma x} \cdot K \cdot {( 2 R - {d}_{2} )}^{- γ} + {σ}^{2}}\end{matrix} ) ] & ( 21 )\end{matrix}$$

FIG. 2 depicts the achievable rates for the collaborative BS transmission 200 and non-collaborative 202 BS transmission according to (20) and (21). The radius of each cell is assumed to be 1 mile. K=−123.7 dB is the path loss at a reference distance of 1 mile. The typical path loss exponent γ=3.8 is used. The antennas are assumed to be omni-directional. BS's transmission power cap is 10 W. We also assume a receiver noise figure of 5 dB, a vertical antenna gain of 10.3 dBi, a channel bandwidth of 1 MHz, and a receiver temperature of 300 K. This corresponds to the interference-free SNR 18 dB at the reference distance, accounting only for path loss while ignoring shadowing and Rayleigh fading.

As shown in FIG. 2, the collaborative BS transmission is always better than non-collaborative BS transmission. It is interesting to see that for a given distance d₁ of MS₁, the maximum rate may be achieved when the distance of MS₂, i.e. d₂ is the same as d₁ for both transmission schemes or vice versa. Furthermore, the achievable rate at a given distance d₁ may decrease inversely with d₂ monotonically. These properties can be easily proved through the close-form expressions of the achievable rates (20).

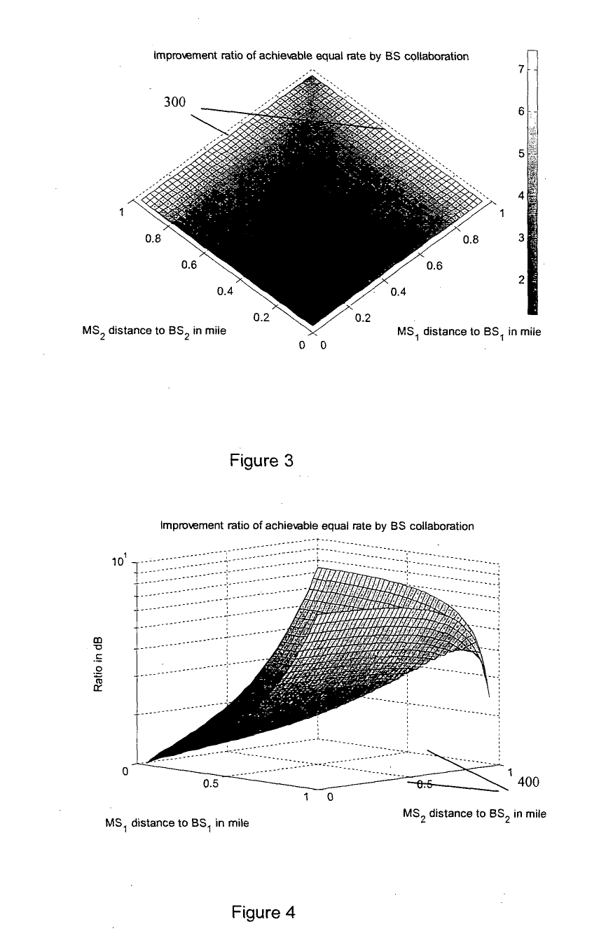

FIG. 3 depicts the achievable rate advantage of collaborative BS transmission over non-collaborative transmission with respect to the MS distances with their serving BSs. FIG. 4 shows another 3-D view of the same picture in FIG. 3. Both figures show clearly that the rate advantage increases with distance. The further distance of MS to its serving BS or the closer to the cell coverage edge 300, 400 the greater the potential rate gain could be obtained through BS collaborative transmission. This makes sense since the closer a MS to its serving BS, the better signal quality received from its serving BS and the less interference received from adjacent cells in a non-collaborative transmission scheme. Collaboration from a relative far away BS might not provide much gain. This figure also shows that the collaboration gain in terms of the rate advantage is determined by the minimum distance to BS of the two MSs. It allows us to define the collaborative zone based on the MS distance to its serving BS.

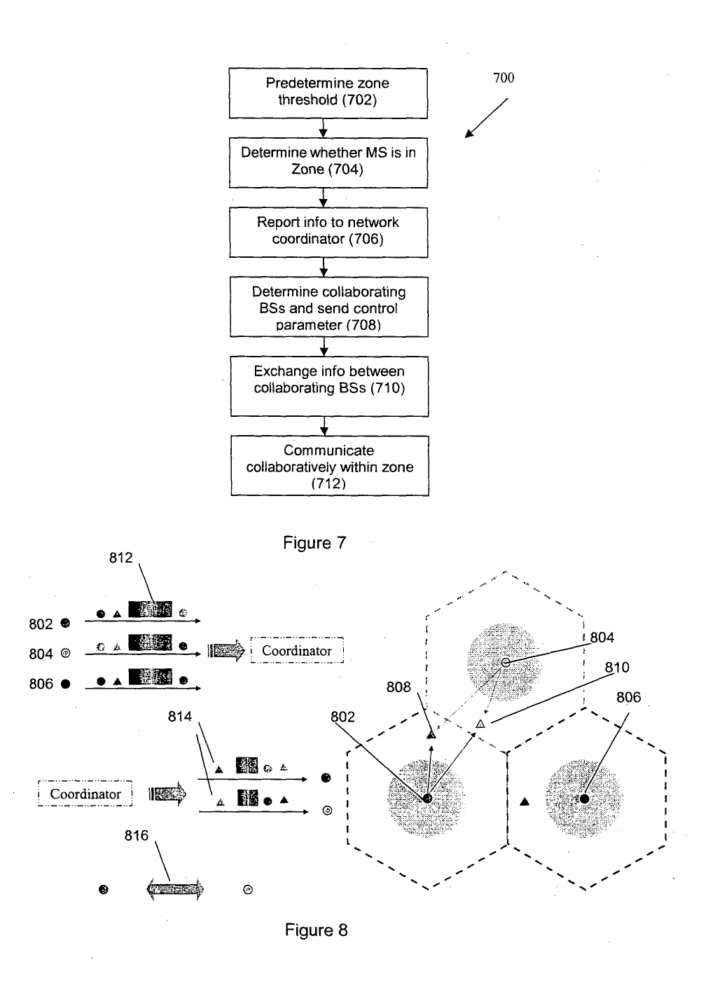

The steps of defining a collaborative zone according to MS locations and communicating subsequently can be implemented as shown in the method 700 of FIG. 7.

At 702 predetermine a threshold for each BS for the collaborative zone.

At 704 obtain distances of MS to their serving BS and compare the distance of each MS with the threshold of the BS and consider those MSs with their distances greater than the threshold within collaborative zone of the BS.

At 706 report to a network coordinator the collaboration parameters, such as Ds of serving BSs and candidate collaborative BSs, IDs of MSs within the collaborative zones, and candidate resources for the MSs.

At 708 determine one or more collaborative BSs depending on the collaboration parameters for each of MS in the collaborative zones and transmitting control parameters to the respective BSs.

At 710 exchange amongst collaborative BSs the data/channel information for the MSs only in the collaborative zone through backhaul.

At 712 transmit signals collaboratively with other BS to MSs in the collaborative zone.

The threshold for the collaborative zone at 702 could be determined by the minimum data rate requirement through (20) (d₁=d₂) or FIG. 2. It could also be determined through the advantage degree of BS collaboration over non-collaboration or FIG. 3 and FIG. 4.

The determination of whether the MS is in the zone at 704, may be implemented in the BS by estimating the received MS signal strength. It can also obtain the distance through a specific control signal, such as ranging signal, if any. Whether a MS is within the well-defined collaborative zone of its serving BS may be determined solely by the BS separately in a distributed way.

The determination of collaborative BSs (BS₂₋ₙ) at 708 by the network coordinator may be implemented by determining whether the BS is one of the associable BSs of another one or more MS (MS₂₋ₙ) within a collaborative zone of one or more the associable BSs of the MS. The determination of collaborative BSs at 708 by the network coordinator may further comprise making sure the BS has a common candidate resources with BS₂₋ₙ.

Once the collaborating BSs are determined the power optimisation to maximise the minimal rate of the MS is determined in (14) and provided as one of the control parameters. Alternatively the power optimization may be to maximise of the total sum-rate of all of the MSs. The network coordinator could be a stand alone node in the network. It could also be co-located with one of the BS (i.e. one of BS is also the coordinator).

The exchange of information at 710 from the network coordinator to the coordinating BSs can be implemented as shown in FIG. 8. In FIG. 8, the dots 802,804,806 represent the 3 BS. The sequence transmitted to coordinator represent some of the control signals at 706. For example, BS 802 transmits its identification no 802, its MS id 808, candidate frequency spectrum 812, and the associable BS id 804.

Then, the coordinator pairs BS 802, BS 804 and MS 808 MS 810 for collaborative transmission. It informs the BS 802, BS 804 with respective control signals 814 at 708.

Last, BS 802 and BS 804 exchange data and channel information 816 before joint transmission to the MS at 710.

The collaborative communication between the BSs and the MS at 712 may be implemented using the linear zero forcing or minimum-mean-squared-error collaboration scheme described previously. For example precoding in (4) may be used long with the zero-forcing matrix in (6).

### Fading Channel

In practice, a wireless signal may experience severe fading in the channel including a slow fading component due to shadowing and a fast fading component due to multipath. Although the achievable rates calculated according to (20) and (21) for AWGN will be deviated significantly in the fading channel, they can still be utilized as shown below.

Shadowing is caused by obstacles between the transmitter and receiver that attenuate signal power through absorption, reflection, scattering, and diffraction, giving rise to random variations of the received power at a given distance. The is most common model for this attenuation is log-normal shadowing being applied to both outdoor and indoor radio propagation environments. Specifically in this model, the average path loss in dB is characterized by the path-loss model as in AWGN above. Additionally, a random shadowing variable is added onto the path loss which is Gaussian distributed with mean zero and a standard deviation σ_{ψ} dB. It also varies slowly and is dependent on the location and environment. On top of the shadowing, a wireless signal will be further attenuated due to multipath which causes the signal to vary frequently in time and within a short distance. The fast multipath fading is usually modelled as a random variable with Rayleigh or Rician distribution.

Since the received signal at each location is a random variable and the Gaussian/Rayleigh/Rician distribution has infinite tails, any mobile in a cell has a nonzero probability of experiencing received power below any value. Therefore we will employ outage capacity to study the collaborative gain as in the cell-coverage study. We will quantify the achievable rates in fading channels for a transmission scheme in terms of throughput at 10% outage.

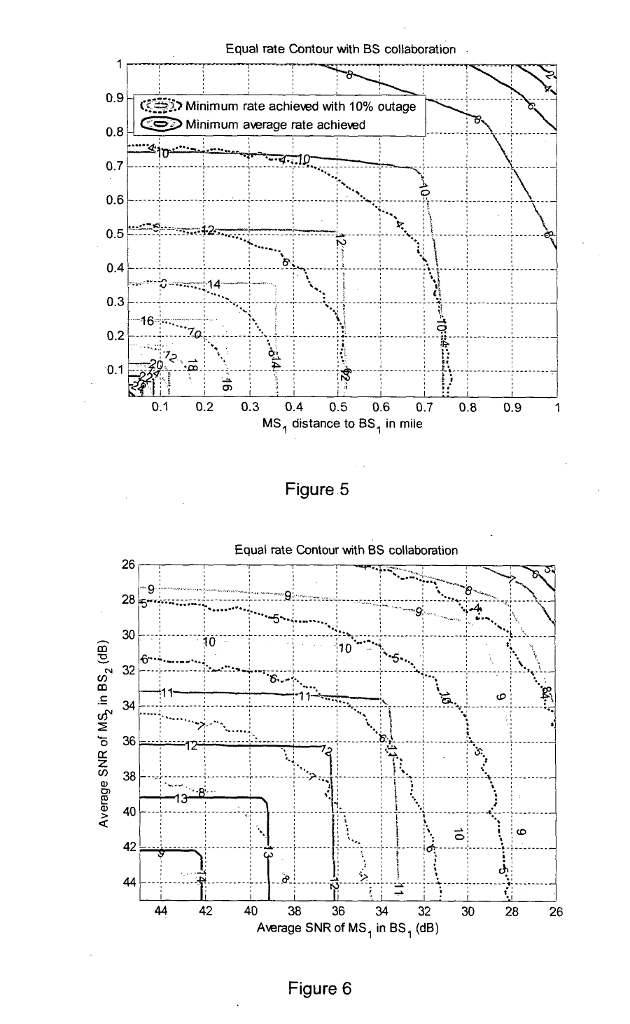

FIG. 5 depicts the achievable rate contour in fading channels (dotted lines) for the collaborative BS transmission with respect to the MS distances to their serving BSs. The shadowing is assumed to be lognormal distribution with mean zero and standard deviation σ_{ψ}=8 dB. Rayleigh fading with zero mean, unit variance complex Gaussian component is assumed for the fast fading. The numbers in the figure denote the achievable rates contour with 10% outage. For comparison, we have included as well the achievable average rate contours (solid lines) which are also corresponding to the achievable rates in AWGN. It shows in the figure that the achievable rate contours of the collaborative BS transmission in fading channels with 10% outage exhibit similar shape as in AWGN channels, but the achievable rates are decreased by about 40%-60%. It implies that the collaborative zone can still be determined by the minimum distance to BS of the two MSs according to the steps described in AWGN channels. However, we need to add in a correction factor when we determine the threshold of the collaborative zone at 702. The correction factor is as expected related to the severity of the fading and its statistics is assumed to be known at the system planning phase.

The correction factor could be determined by FIG. 5. Say we want to achieve rate 4 bps/Hz in the fading channel. From FIG. 5 we know that this corresponds to 10 bps/Hz in AWGN channel (the dash line and the solid line are overlapping in the figure). So we may use the distance calculated from AWGN, but for different achievable rate. Thus 10 bps/Hz would be used in determining the threshold for distance at 702.

As the received power varies slowly due to shadowing, it is possible for MS to measure the average signal-to-noise ratio (SNR) and mitigate the effect of shadowing fading. Once the SNR level is available at each MS, the collaborative zone can also be determined through SNR values.

FIG. 6 illustrates the achievable rate contour in fading channels (dotted lines) for the collaborative BS transmission with respect to the MS SNRs in their serving BSs. The same simulation setup and denotation is used as in previous simulations. The achievable average rate contours (solid lines) corresponding to AWGN is also shown for comparison. From FIG. 6, similar conclusions can be drawn that the achievable rate contours of the collaborative BS transmission in fading channels with 10% outage exhibit similar shape as in AWGN channels, implying the collaborative zone can be determined through the SNR of a MS in its serving BS similar to the steps described above. Comparing FIG. 6 and FIG. 5, it can be found that the difference of the achievable rates in the fading channels and AWGN channel in FIG. 6 is smaller than that in FIG. 5. With the knowledge of SNR of each MS in the case of FIG. 6, the actual achievable rates in fading channels is about 60% of the achievable rates in AWGN, going up from the 40%-60% as in the case of FIG. 5 with location information. This means that we can have a smaller and more accurate correction factor if we have the knowledge of SNR.

With SNR of each MS, we can define the collaborative zone accordingly similar to the steps in AWGN, replacing the distance information with SNR. The corrected rate would be used in determining the threshold for SNR at 702.

The described embodiment should not be construed as limitative. For example, the described embodiment describes the collaborative zone as a method but it would be apparent that the method may be implemented as a device, more specifically as an Integrated Circuit (IC). In this case, the IC may include a processing unit configured to perform the various method steps discussed earlier, but otherwise operate according to the relevant communication protocol. For example the described embodiment is particularly useful in a cellular network, such as a 4G network, but it should be apparent that the described embodiment may also be used in other wireless communication networks. Thus MS devices, BS and other network infrastructure may incorporate such ICs or otherwise be programmed or configured to operate according to the described method.

Whilst there has been described in the foregoing description embodiments of the present invention, it will be understood by those skilled in the technology concerned that many variations in details of design, construction and/or operation may be made without departing from scope as claimed.

1. A method of communication comprising:
determining whether a mobile station (MS) is within a collaborative zone with respect to a first base station (BS₁),
if the MS is within the collaborative zone:
the BS₁ transmitting one or more collaboration parameters to a network coordinator,
the network coordinator determining one or more collaborative base stations (BS₂₋ₙ) depending on the collaboration parameters,
the network coordinator transmitting control parameters to the BS₁ and the BS₂₋ₙ,
the BS₁ exchanging information with the BS₂₋ₙ in accordance with the control parameters, and
the BS₁ and the BS₂₋ₙ collaboratively transmitting data to the MS in accordance with the control parameters.

2. The method according to claims 1, wherein the determining whether the MS is within the collaborative zone comprises determining whether a distance between the MS and the BS₁ is over a predetermined threshold.

3. The method according to claim 1 or 2, wherein the determining whether the MS is within the collaborative zone comprises determining whether a signal to noise ratio (SNR) is below a predetermined threshold.

4. The method according to claim 1 or 2, wherein the determining whether the MS is within the collaborative zone comprises the BS₁ transmitting at least an MS ID for the MS to the network coordinator and determining whether the network coordinator receives the same MS ID from other base stations.

5. The method according to any one of the preceding claims further comprising determining a collaborative zone threshold based on the minimal achievable rate of each MS.

6. The method according to any one of claims 1 to 5 further comprising determining a collaborative zone threshold based on the sum rate of all MS within the collaborative zone of BS₁ and the BS₂₋ₙ.

7. The method according to claim 6 or 7 wherein the determining the collaborative zone threshold is also based on a correction factor for channel fading.

8. The method according to any one of the preceding claims wherein if the MS is not within the collaborative zone, the BS₁ will non collaboratively transmit data to the MS.

9. The method according to any one of the preceding claims wherein the one or more collaboration parameters are selected from the group consisting of a BS₁ ID, a MS ID, a candidate resource, associable BS IDs and any combination thereof.

10. The method according to any one of the preceding claims wherein the control parameters comprise transmission resources and/or collaborative BS IDs for each MS.

11. The method according to claims 1 to 7 wherein the BS₁ exchanging information with the BS₂₋ₙ comprising the BS₁ transmitting via a wired backhaul data to be transmitted to the MS and the channel information between the MS and the BS₁ in accordance with the control parameters to the BS₂₋ₙ one or more other collaborative base stations.

12. The method of communication according to claim 12, wherein the BS₁ is exchanging information with the BS₂₋ₙ further comprising the BS₁ receiving via the wired backhaul the data to be transmitted to a further mobile station (MS₂) within a collaborative zone of the BS₂₋ₙ and the channel information between the MS₂ and the respective BS₂₋ₙ in accordance with the control parameters.

13. The method according to any one of the preceding claims wherein the collaboratively transmitting data comprises a linear zero-forcing or minimum-mean-squared-error collaboration scheme.

14. The method according to any one of claims 1 to 3 or 5 to 13 when dependent on any one of claims 1 to 3, wherein the determining whether the MS is within the collaborative zone is done independently by the BS₁.

15. A method for signal transmission from two or more base stations (BSs) collaboratively to one or more mobile stations (MSs) which have a 1st parameter with its associated BS exceeding/below a predetermined threshold, the method comprising:
each BS reporting to a network coordinator a BS ID, and the ID, candidate resources, and associable BS IDs for each of the associated MS,
the network coordinator determining the transmission resources and other collaborative BS IDs for each MS,
the network coordinator informing each BS, the transmission resources and said collaborative BS IDs for each MS,
each said BS exchanging information with said collaborative BSs for a MS that is associated to said each said BS, and
each said BS, together with said collaborative BSs transmit signals with the said transmission resources simultaneously to a group of MSs sharing the same BS set, said BS set comprising the associated BSs and collaborative BSs.

16. An integrated circuit configured to communicate according to the method in any of claims 1 to 15.

17. A mobile station configured to communicate according to the method in any of claims 1 to 15.

18. A base station configured to communicate according to the method in any of claims 1 to 15.

19. A network coordinator configured to communicate according to the method in any of claims 1 to 15.
